(19) United States
(12) Patent Application Publication
(10) Pub. No.: US 2025/0284059 A1
(43) Pub. Date: Sep. 11, 2025

(54) SYSTEM FOR PROTECTING TELECOMMUNICATIONS CABLE SPLICE ARRANGEMENTS

(71) Applicant: CommScope Technologies LLC, Hickory, NC (US)

(72) Inventors: Yu LU, Eden Prarie, MN (US); Ponharith NHEP, Savage, MN (US); Scott L. CARLSON, Bloomington, MN (US); Chinmay M. BENDALE, Eden Prairie, MN (US); Jaime GONZALEZ BATISTA, Prior Lake, MN (US); Paige E. CANZONIERI, Brooklyn Park, MN (US)

(73) Assignee: CommScope Technologies LLC, Hickory, NC (US)

(21) Appl. No.: 18/702,581

(22) PCT Filed: Oct. 18, 2022
(86) PCT No.: PCT/US2022/047040

§ 371 Date: Apr. 18, 2024

Related U.S. Application Data
(60) Provisional application No. 63/262,648, filed on Oct. 18, 2021.

(51) Int. Cl. G02B 6/255

(52) U.S. Cl. CPC G02B 6/2558

(57) ABSTRACT

A splice arrangement including a splice protection housing that defines a passage that extends lengthwise through the splice protection housing from a first end of the splice protection housing to an opposite second end of the splice protection housing. The splice arrangement may also include a first fiber optic cable and a second fiber optic cable. First optical fibers of the first fiber optic cable and second optical fibers of the second fiber optic cable may be coupled together at a splice location positioned within the passage of the splice protection housing.

### CROSS-REFERENCE TO RELATED APPLICATION

This application is being filed on Oct. 18, 2022 as a PCT International Patent Application and claims the benefit of U.S. Patent Application Ser. No. 63/262,648, filed on Oct. 18, 2021, the disclosure of which is incorporated herein by reference in its entirety.

### BACKGROUND

Optical fiber communications systems are extensively used in the telecommunications industry due to their large information carrying capacity, their virtually noise-free performance and the long span distances achievable before regeneration and amplification of the signal is required. In many communication systems employing optical fibers, splice locations are provided where optical fibers are coupled together. Often these splice locations are located remote from central offices, for example, at customer premises or areas serviced by local area networks.

At each splice location, optical fibers must be separated from outer protective cable components for splicing and termination. However, removal of optical fibers from their outer protective cabling components makes the optical fibers vulnerable to damage. Protection of splice locations after splicing is an important consideration. One example of a telecommunication splice arrangement is shown in U.S. Patent Publication No. 2020/0348469, the disclosure of which is incorporated herein by reference.

### SUMMARY

One aspect of the disclosure relates to a system for protecting a splice of telecommunications cable. The system can include a splice protection housing having a length that extends between a first end and a second end. The splice protection housing defines a fiber routing and splice containment passage the extends between a first end to an opposite, second end of the splice protection housing. The splice protection housing further includes first and second anchoring pockets at the first and second ends, respectively. An adhesive injection port is defined by the splice protection housing and in communication with the splice containment passage is positioned between adhesive vent ports positioned toward the first and second ends that are also defined by the splice protection housing.

The system may also include a first fiber optic cable. The first fiber optic cable may include a first outer jacket that contains first optical fibers and a first buffer tube and first strength members. The first fiber optic cable may be anchored to the first anchoring pocket.

The system may further include a second fiber optic cable. The second fiber optic cable may include a second outer jacket that contains second optical fibers and a second buffer tube and second strength members. The second fiber optic cable may be anchored to the second end anchoring pocket.

The first optical fibers and the second optical fibers may be coupled together at a splice location positioned within the splice containment passage. The splice protection housing may surround and support the splice location to provide structural reinforcement thereto.

The first and second anchoring pockets may include major and minor dimensions that are transposed 90 degrees from major and minor dimensions of the splice containment passage.

A variety of additional aspects will be set forth in the description that follows. The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of one embodiment of a system for protecting a splice of telecommunication cables including a splice protection housing in accordance with principles of the present disclosure;

FIG. 1A is a section view of the system for protecting a splice of telecommunication cables of FIG. 1, showing a splice containment passage;

FIG. 2 is a top view of the system for protecting a splice of telecommunication cables of FIG. 1;

FIG. 3 is a side view of the system for protecting a splice of telecommunication cables of FIG. 1;

FIG. 4 is a bottom view of the system for protecting a splice of telecommunication cables of FIG. 1;

FIG. 5 is a front view of the system for protecting a splice of telecommunication cables of FIG. 1;

FIG. 6 is an exploded perspective view of the system for protecting a splice of telecommunication cables of FIG. 1;

FIG. 7 is an exploded side view of the system for protecting a splice of telecommunication cables of FIG. 1;

FIG. 8 is a perspective view of the main body of the splice protection housing shown in FIG. 1;

FIG. 9 is a top view of the main body of the splice protection housing shown in FIG. 1;

FIG. 10 is a side view of the main body of the splice protection housing shown in FIG. 1;

FIG. 11 is a front view of the main body of the splice protection housing shown in FIG. 1;

FIG. 12 is a perspective view of the cover of the splice protection housing shown in FIG. 1;

FIG. 13 is a bottom view of the cover of the splice protection housing shown in FIG. 1;

FIG. 14 is a top view of the cover of the splice protection housing shown in FIG. 1;

FIG. 15 is a front view of the cover of the splice protection housing shown in FIG. 1; and

FIG. 16 is a perspective view of one embodiment of a splice protection housing in accordance with the principles of the present disclosure.

FIG. 17 is a perspective view of an embodiment of a splice protection housing with a fiber optic cable pre-terminated with a connection in accordance with the principles of the present disclosure.

FIG. 18 is a perspective view of another embodiment of a splice protection housing in accordance with the principles of the present disclosure.

### DETAILED DESCRIPTION

Aspects of the present disclosure will be described more fully hereinafter with reference to the accompanying drawings, in which illustrative embodiments are shown. This disclosure may, however, be embodied in many different forms and should not be construed as limited to the embodiments set forth herein; rather, these embodiments are provided so that this disclosure will be thorough and complete, and will fully convey the scope of the invention to those skilled in the art.

Splice protections are often used in the field to join two lengths of fiber optic cables together. For example, a splice protection may be used to splice a first cable to a second cable to provide an extended cable length or to provide a cable repair. For the present application, the splice protection is used to optically connect a fiber optic connector (e.g., a multi-fiber optical connector such as a hardened multi-fiber optical connector (HMFOC) to a longer cable). In certain examples, the fiber optic connector is pre-terminated at the end of a relatively short length of fiber-optic cable to form a connectorized tether. The non-connectorized end of the connectorized tether is spliced to a longer length of cable at a joint to provide a connector as cable assembly such as a connector eyes to drop cable assembly.

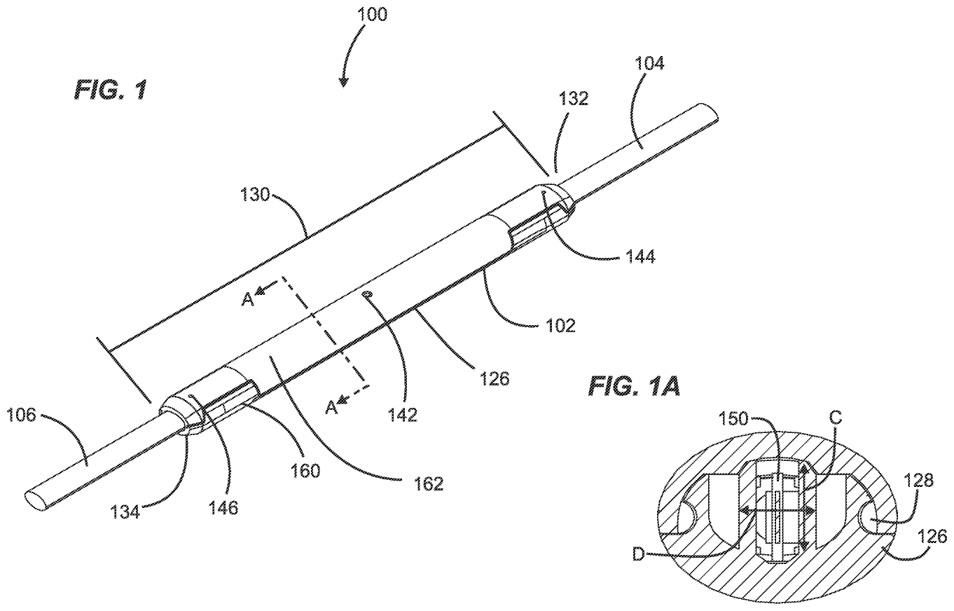

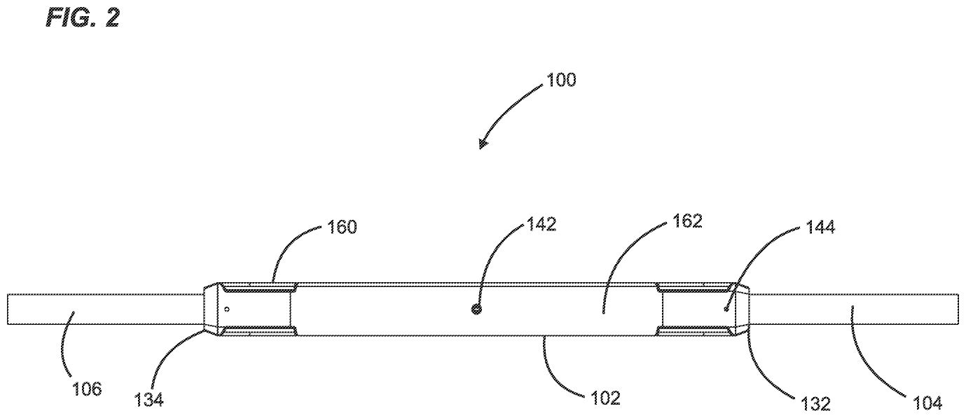

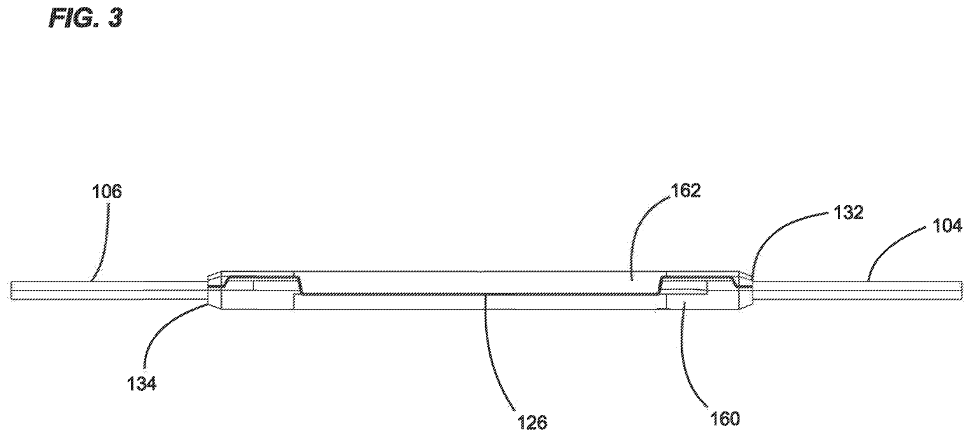

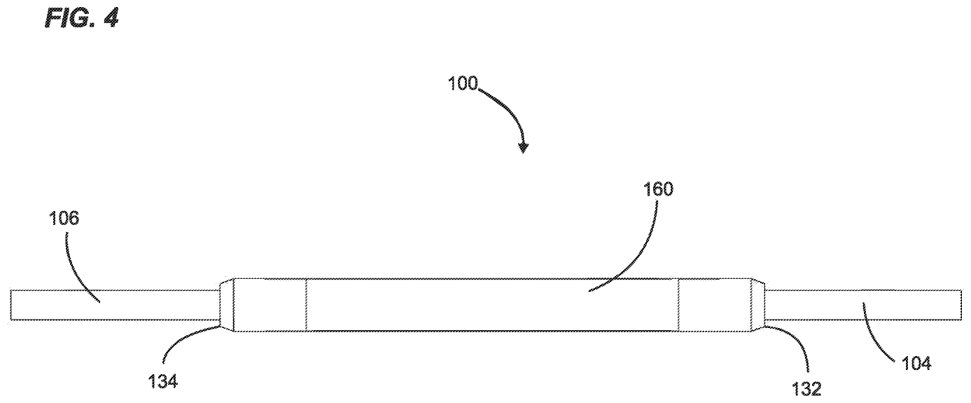

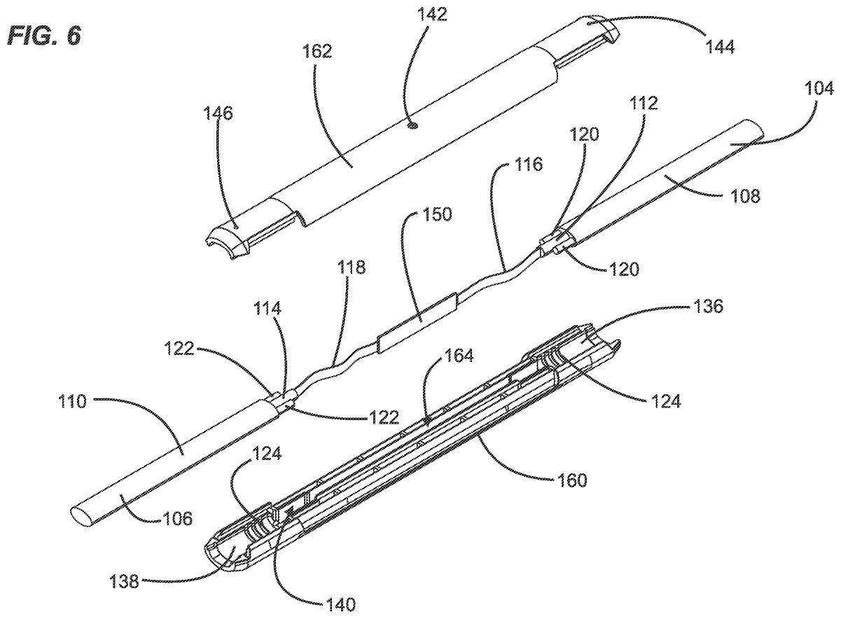

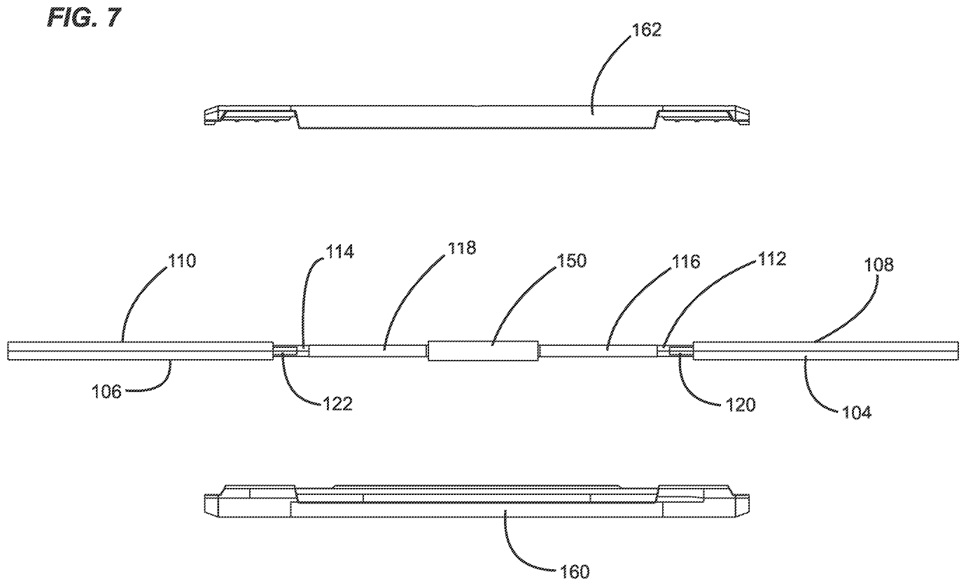

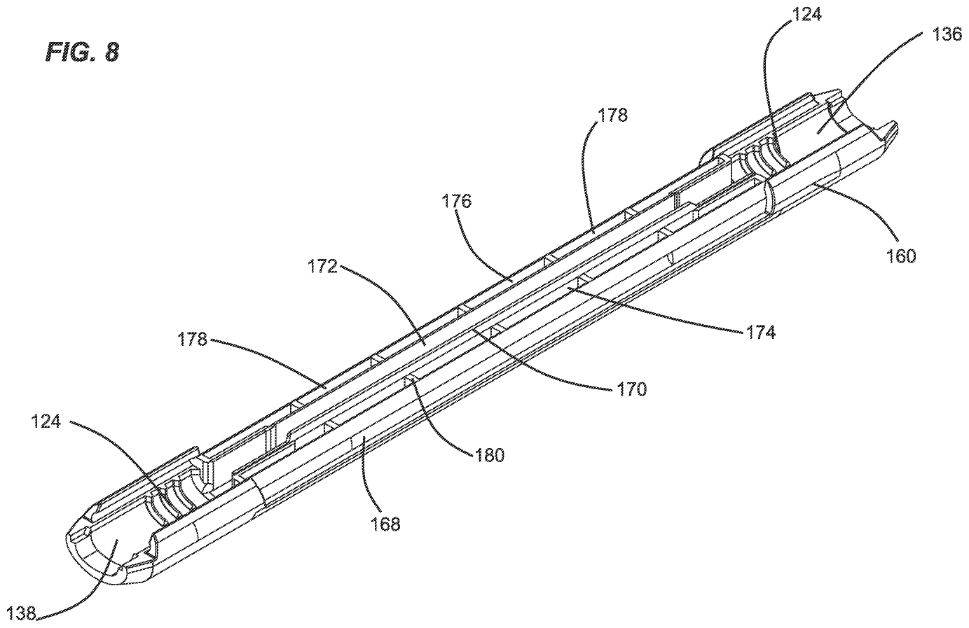

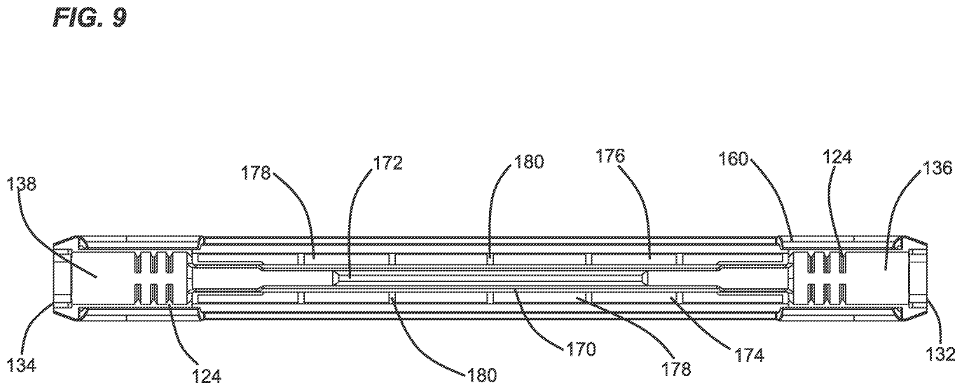

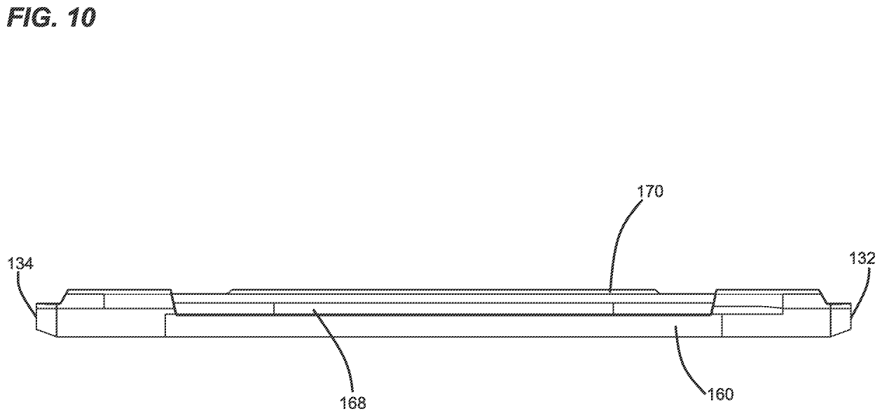

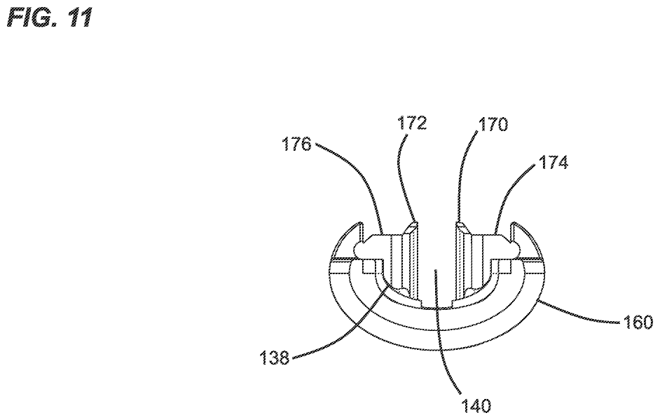

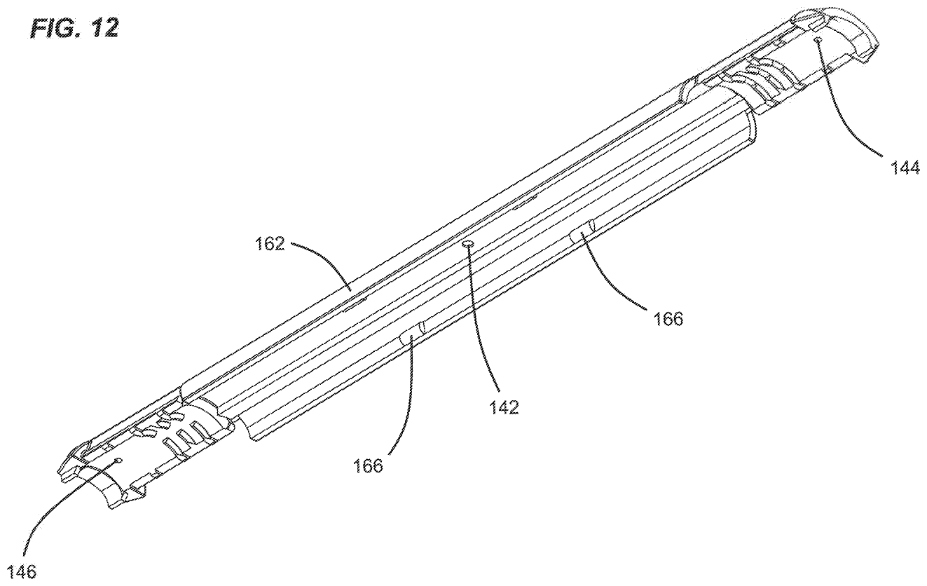

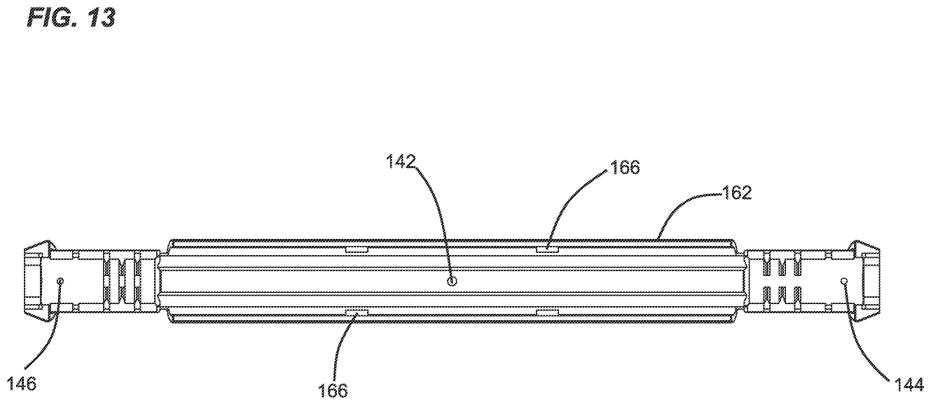

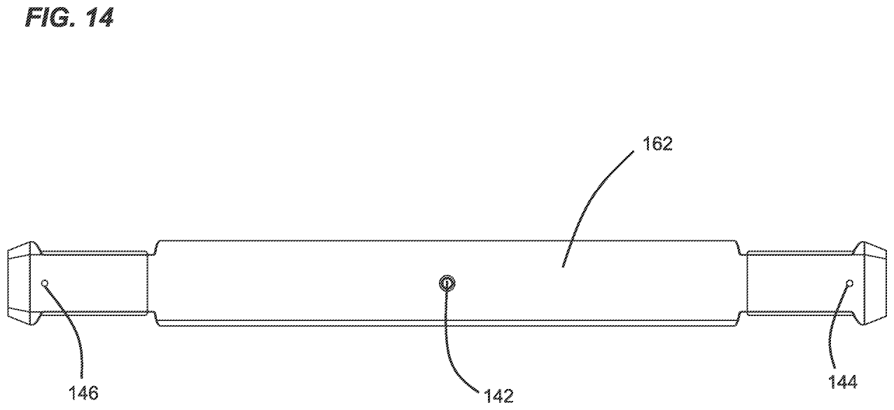

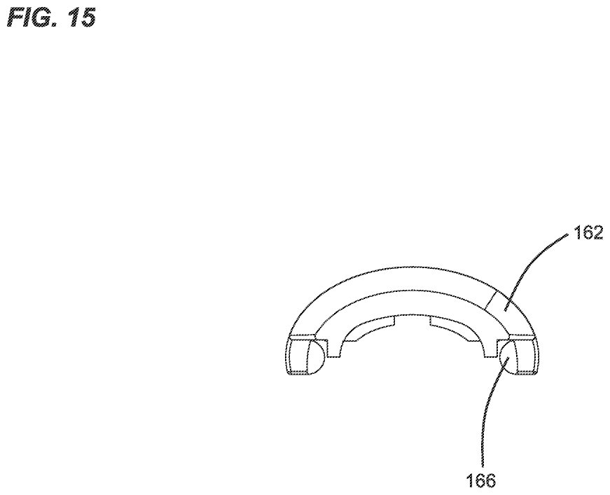

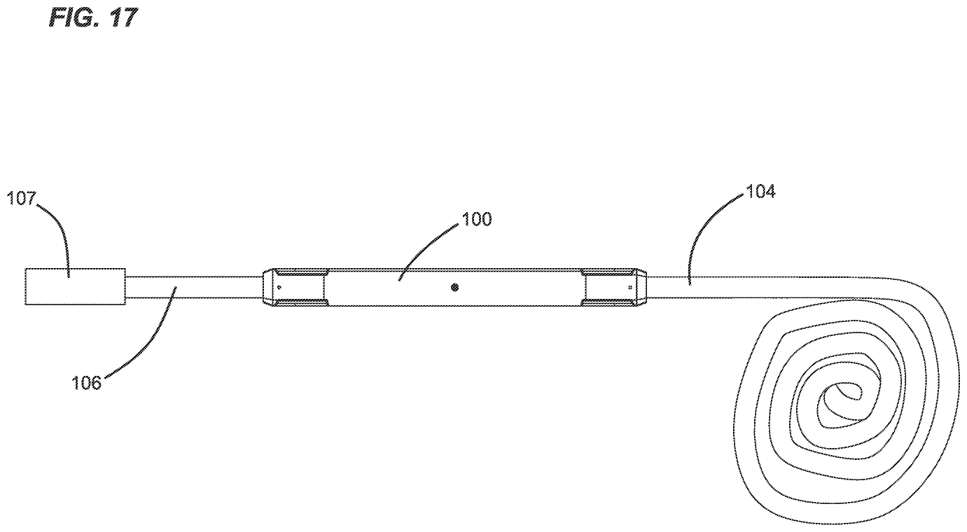

Referring to FIGS. 1-17, one example of a splice for telecommunication cable 100 according to the disclosure is shown. The splice 100 may include a splice protection housing 102, a first fiber optic cable 104 (e.g., a single fiber or multi-fiber cable), and a second fiber optic cable 106 (e.g., a single fiber or multi-fiber cable). The first and second fiber optic cables 104, 106 may each have on the order of 12 to 48 fibers; however, alternative implementations may include fewer or more fibers. In certain examples, and as shown in FIG. 17, first fiber optic cable 104 is pre-terminated with a connector 107.

In certain embodiments, first and second fiber optic cables 104, 106 do not have round cross sections. Instead, each has an elongate cross-sectional profile having a major axis A and a minor axis B that are perpendicular relative to one another. Each cable 104, 106 includes an outer jacket 108, 110, which defines the outer cross-sectional profile, a buffer tube 112, 114 within the jacket which contains the optical fibers 116, 118, and two strength members 120, 122 aligned along the major axis on opposite sides of the buffer tube. In one example, the strength members each has a construction including a glass fiber reinforced polymer (e.g., an epoxy reinforced by glass rovings).

In the example shown, each of the cables 104, 106 includes a plurality of optical fibers 116, 118. The optical fibers 116, 118 of each of the cables 104, 106 are spliced together at a splice location 150 within the splice protection housing. In a preferred example, the optical fibers 116, 118 at the splice location 150 are arranged in a planar configuration in which the optical fibers are aligned along a plane. In certain examples, the splice location 150 can be protected by a film or other reinforcing structure bonded to the optical fibers 116, 118 that extends across the splice location. A cross-sectional profile of the splice location 150 can have a major dimension and a minor dimension because the splice location can be arranged in a planar configuration. In certain examples, the optical fibers 116, 118 of one or both of the cables 104, 106 can be ribbonized (bonded together by a matrix material such as acrylate) adjacent the splice location 150 to assist in maintaining an order and positioning of the optical fibers prior to splicing.

Splice protection housing 102 has an elongate configuration and includes a length 130 that extends between opposite first 132 and second ends 134. In certain embodiments, the splice protection housing 102 defines first and second cable anchoring pockets 136, 138 respectively adjacent the first and second ends. The splice protection housing 102 also defines a fiber routing and splice containment passage 140 that extends through the length 130 of the splice protection housing between the first and second cable anchoring pockets 136, 138. The fiber routing and splice containment passage 140 is in communication with the first and second cable anchoring pockets 136, 138.

Splice protection housing 102 further includes a main body 160 and a cover 162 that enclose an interior passage 164 when they are joined together. Fiber routing and splice containment passage 140 and first and second cable anchoring pockets 136, 138 are defined by interior passage 164. In one example cover 162 can be secured to main body 160 by a snap-fit connection. Cover 162 may include a plurality of securing tabs 166 positioned along the length of the cover that selectively engage securing channels 168 that extend along the length of main body 160. In another example, cover 162 and main body 160 may be secured to each other by an arrangement of latches. In one example, latches are provided at the first and second cable anchoring pockets 136, 138 as well as at at least one intermediate location between the first and second cable anchoring pockets.

Splice protection housing 102 may be formed from any suitable material with plastic such as but not limited to polypropylene being a desirable material. It will be appreciated that the splice protection housing 102 can be made from, plastics, ceramics, acrylics, rubber, combinations thereof, or any other solid material.

An adhesive injection port 142 is defined by the splice protection housing 102 in communication with the fiber routing and splice containment passage 140. In one example, the adhesive injection port 142 is located at a midpoint between the first and second ends of the splice protection housing. First and second adhesive vent ports 144, 146 are defined by the splice protection housing 102 respectively in communication with the first and second cable anchoring pockets 136, 138. The adhesive injection port 142 as well as the first and second vent ports 144, 146 are all accessible at an exterior of the splice protection housing 102.

By injecting an adhesive such as epoxy into the splice protection housing through the adhesive injection port, the fiber routing and spice containment passage 140 as well as the first and second cable anchoring pockets 136, 138 can be filled with adhesive in one shot. It will be appreciated that the adhesive is preferably continuously injected until adhesive begins to bleed through both of the first and second vent ports 144, 146.

In one example, the cover 162 can define the adhesive injection port 142 as well as the first and second vent ports 144, 146. In another example, the main body 160 can define the adhesive injection port 142 as well as the first and second vent ports 144, 146. In yet another example, the adhesive injection port 142 and first and second vent ports 144, 146 may be defined on a combination of the main body 160 and cover 162. In some embodiments, multiple adhesive injection ports 142 can be included and positioned in any suitable location on the splice protection housing 102 without departing from the principles of this disclosure. In some examples, first and second vent ports 144, 146 may not be present, and clearance between the housing and the cable provides venting.

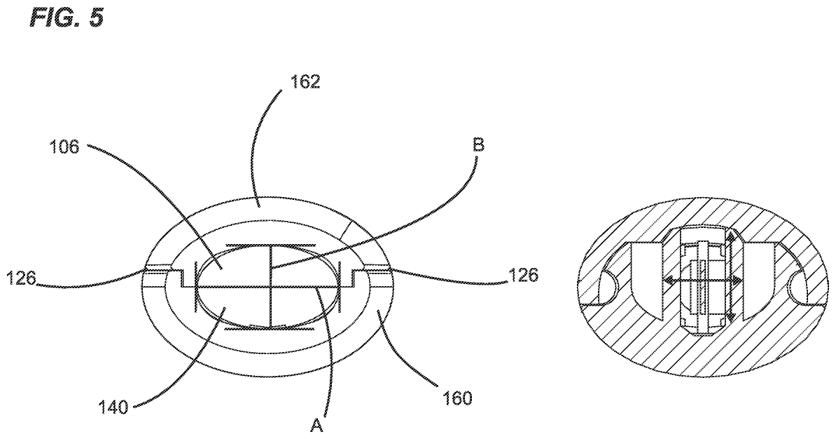

As shown in FIG. 5, the first and second cable anchoring pockets 136, 138 each have a cross-sectional profile including a major dimension A and a minor dimension B. Similarly, and as shown in FIG. 1A, the fiber routing and splice containment passage 140 has a cross-sectional profile including a major dimension C and a minor dimension D. The major dimension C and the minor dimension D of the cross-sectional profile of the fiber routing and splice containment passage 140 are transposed 90° relative to the major dimensions A and the minor dimensions B of the first and second cable anchoring pockets 136, 138. In some examples, the cross-sectional profile of the fiber routing and splice containment passage 140 has an area that is less than 25%, or less than 20%, less than 15% or less than 10% of a total cross-sectional profile of the splice protection housing 102.

In one example, shown in detail in FIGS. 1A, 8, and 12, the fiber routing and splice containment passage 140 can be defined by inner walls 170, 172 of the splice protection housing 102. In one example, the inner walls 170, 172 can be generally parallel to one another. The inner walls 170, 172 are separated from exterior defining portions of the cable joint housing by first and second open regions 174, 176 that extend along the length of the cable joint housing on opposite sides of the fiber routing and spice containment passage. The open regions can be subdivided into a plurality of open chambers 178 by reinforcing ribs 180 that extend between the inner walls 170, 172 and the exterior defining portions of the cable joint housing. In certain examples, relatively small amounts of excess adhesive injected into the fiber routing and splice containment passage 140 may overflow into the first and second open regions 174, 176.

The first and second cable anchoring pockets 136, 138 include features for assisting in effectively bonding the cables 104, 106 within their respective pockets and for assisting in retaining the cover 162 on the main body 160 of the splice protection housing 102. For example, the first and second cable anchoring pockets 136, 138 include adhesive retention ribs 124 between which the adhesive flows when the adhesive is injected into the cable joint housing. Once the adhesive cures, mechanical interference between the adhesive and the adhesive retention ribs 124 provides an interlock that prevents the adhesive from being axially withdrawn from the ends of the splice protection housing 102. At the first and second cable anchoring pockets, the seam 126 between the cover 162 and the main body 160 of the cable joint housing is defined with a predefined gap 128 that allows the adhesive to flow into the gap to provide bonding at the seam between the cover and the main body of the splice protection housing 102.

To install the splice protection housing 102 over the first and second cables 104, 106, the first and second cables are first prepared. For example, the cables 104, 106 are so prepared by initially stripping off a section of the cable outer jacket 108, 110 to expose the buffer tubes 112, 114 and the strength members 120, 122. The buffer tubes 112, 114 are trimmed to expose the optical fibers 116, 118 of the cables 104, 106. Preferably, a sufficient length of optical fibers 116, 118 is exposed to allow for performing a mass fusion splice between the optical fibers and to provide sufficient length of optical fiber through the splice protection housing 102. The strength members 120, 122 are also trimmed such that relatively short lengths of the strength members project beyond ends of the outer jackets 108, 110 of the cables 104, 106. As previously described, once the cables 104, 106 have been prepared and the optical fibers 116, 118 have been spliced together, the optical fibers can be protected by a structure such as a laminate film or other structure.

Next, the splice location 150 of the optical fibers 116, 118 is positioned within the fiber routing and splice containment passage 140 and the prepared ends of the fiber optic cables 104, 106 are positioned within the respective cable anchoring pockets 136, 138. The splice location 150 is preferably positioned at a central location along the length of the main body 160 of splice protection housing 102. The cover 162 is then mounted on the main body 160 of the splice protection housing 102 to enclose the fiber routing and splice containment passage 140 as well as to enclose the cable anchoring pockets 136, 138. An adhesive such as epoxy is then injected into the centrally located adhesive injection port 142. Injection of the adhesive continues until the fiber routing and splice containment passage 140 and the cable anchoring pockets 136, 138 are filled with adhesive. Adhesive flowing from both of the adhesive vent ports 144, 146 provides an indication that the fiber routing and splice containment passage 140 as well as the cable anchoring pockets 136, 138 are filled with adhesive. Once the adhesive has cured, the splice protection housing 102 installation processes is complete.

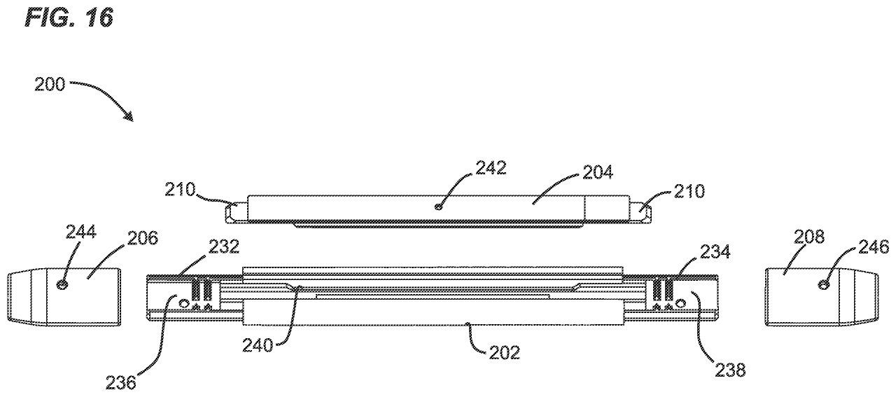

FIG. 16 shows an alternative embodiment of a splice protection housing 200 in accordance with the principles of this disclosure. Splice protection housing 200 is similar in many ways to the embodiment described above but rather than a two-piece construction, this embodiment is made of four parts. In the embodiment shown, splice protection housing 200 includes a main body 202, a cover 204, and two end caps 206, 208. In one example, cover 204 is secured to main body 202 by the two end caps 206, 208 rather than by snap-fit as in the prior embodiment. Cover 204 includes end tabs 210 that selectively engage end caps 206, 208 when splice protection housing 200 is assembled. In certain embodiments, cover 204 may be snap-fit onto main body 202, with end caps 206, 208 further securing the cover to the main body. When end caps 206, 208 secure cover 204 to main body 202, first and second cable anchoring pockets 236, 238 are formed at either end of splice protection housing 202 by a combination of cable anchoring tabs 232, 234 that are integrally formed in main body 202 and end caps 206, 208.

Splice protection housing 200 also includes a fiber routing and splice containment passage 240 that has a cross-sectional profile including a major dimension and a minor dimension. The major dimension and the minor dimension of the cross-sectional profile of the fiber routing and spice containment passage 240 are transposed 90° relative to a major dimension and minor dimension of the first and second cable anchoring pockets 236, 238.

In one example, splice protection housing 200 also includes an adhesive injection port 242 and first and second adhesive vent ports 244, 246. The adhesive injection port 242 is located at a midpoint between the first and second ends of the splice protection housing, is defined by the cover 204, and is in communication with fiber routing and splice containment passage 240. First and second adhesive vent ports 244, 246 are defined by the end caps 206, 208 respectively in communication with the first and second cable anchoring pockets 236, 238. The adhesive injection port 242 as well as the first and second vent ports 244, 246 are all accessible at an exterior of the splice protection housing 200.

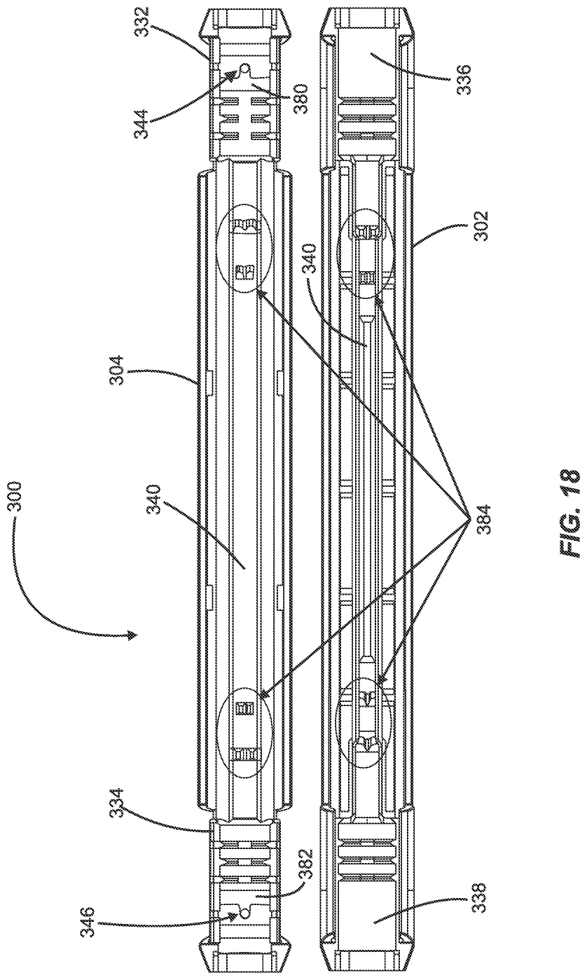

FIG. 18 shows an alternative embodiment of a splice protection housing 300 in accordance with the principles of this disclosure. Splice protection housing 300 is similar in many ways to the embodiments described above but rather than filling the length of the housing with adhesive, adhesive is restricted to the ends 332, 334.

In the embodiment shown, splice protection housing 300 includes a main body 302 and a cover 304. In one example, cover 304 is secured to main body 302 by a snap-fit. When cover 304 is secured to main body 302, first and second cable anchoring pockets 336, 338 are formed at either end of splice protection housing 302. Splice protection housing 300 also includes a fiber routing and splice containment passage 340 that has a cross-sectional profile including a major dimension and a minor dimension. The major dimension and the minor dimension of the cross-sectional profile of the fiber routing and spice containment passage 340 are transposed 90° relative to a major dimension and minor dimension of the first and second cable anchoring pockets 336, 338.

First and second adhesive injection ports 344, 346 are defined by the end 332, 334 of cover 304, each respectively in communication with the first and second cable anchoring pockets 336, 338. The first and second adhesive injection ports 344, 346 are each accessible at an exterior of the splice protection housing 300. First and second adhesive injection sites 344, 346 are each provided with an associated first and second recessed groove 380, 382, as well as being in communication with first and second cable anchoring pockets 336, 338.

Adhesive injected into first and second adhesive injection ports 344, 346 is prevented from running into the central portion of splice containment passage 340 by barriers 384. Barriers 384 permit fibers to be routed through but block adhesive from passing. In embodiments, barriers 384 are each formed with a body portion associated with main body 304 and a cover portion associated with cover 302. When main body 304 and cover 302 are mated together, the body portion and cover portion of each barrier is likewise mated to form a complete barrier. Example embodiment 300 depicts two barriers between a central region of the spice containment 340 and each of first and second cable anchoring pockets 336, 338, but other numbers of barriers are envisioned and supported. In embodiments, at least one barrier between a central region of splice containment passage 340 and each of first and second cable anchoring pockets 336, 338 may be desirable. Example embodiment 300 may be advantageous for bonding cable and short sections of fibers with adhesive while leaving the central splice section free of adhesive.

The various examples described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

What is claimed is:

1. A system for protecting a splice of telecommunications cable, the system comprising;
a splice protection housing having a length that extends between a first end and a second end;
the splice protection housing defining a fiber routing and splice containment passage extending between the first and second ends;
first and second cable anchoring pockets respectively at the first and second ends;
the splice protection housing defining a first adhesive vent port in communication with the first cable anchoring pocket and a second adhesive vent port in communication with the second cable anchoring pocket;
the splice protection housing defining an adhesive injection port positioned between the first and second adhesive vent ports and in communication with the fiber routing and splice containment passage;
a first length of fiber optic cable including at least one first optical fiber;
a second length of fiber optic cable including at least one second optical fiber;
the at least one optical fiber spliced to the at least one second optical fiber at a splice location;
the splice location disposed within the fiber routing and splice containment passage;
the first length of optic cable secured within the first cable anchoring pocket; and
the second length of optic cable secured within the second cable anchoring pocket.

2. The system of claim 1, wherein the first length of fiber optic cable is terminated by a connector.

3. The system of claim 1, wherein the adhesive injection port is centrally located between the first and second ends of the splice protection housing.

4. The system of claim 1, wherein the splice protection housing comprises a main body and a cover.

5. The system of claim 4, wherein the cover and main body are secured to each other by a snap-fit.

6. The system of claim 5, wherein the adhesive injection port and adhesive vent ports are defined by the cover.

7. The system of claim 1, wherein the first and second cable anchoring pockets have a first major dimension and a first minor dimension, the first major dimension greater than the first minor dimension.

8. The system of claim 7, wherein the fiber routing and splice containment passage has a second major dimension and a second minor dimension, the second major dimension greater than the second minor dimension.

9. The system of claim 8, wherein the first major and minor dimensions are transposed 90° relative to the second major and minor dimension.

10. The system of claim 1, wherein the fiber routing and splice containment passage is defined by two inner walls that extend between the cable anchoring pockets.

11. The system of claim 2, further comprising an adhesive material contained within the splice protection housing for encapsulating the first optical fibers and the second optical fibers.

12. The system of claim 1, wherein the splice protection housing is factory or field installable.

13. A splice protection housing comprising;
a length that extends between a first end and a second end;
first and second cable anchoring pockets respectively at the first and second ends;
a fiber routing and splice containment passage extending between the first and second cable anchoring pockets;
a plurality of adhesive vent ports in communication with the first and second cable anchoring pockets; and
an adhesive injection port positioned between the adhesive vent ports and in communication with the fiber routing and splice containment passage.

14. The splice protection housing of claim 13, further comprising a main body and a cover.

15. The splice protection housing of claim 14, wherein the cover attaches to the main body by a snap-fit.

16. The splice protection housing of claim 13, wherein the housing is adapted to receive adhesive material for encapsulating optical fibers.

17. The splice protection housing of claim 13, wherein the fiber routing and splice containment passage is defined by two inner walls that extend between the cable anchoring pockets.

18. The system of claim 13, wherein the first and second cable anchoring pockets have a first major dimension and a first minor dimension, the major dimension greater than the minor dimension.

19. The system of claim 18, wherein the fiber routing and splice containment passage has a second major dimension and a second minor dimension, the second major dimension greater than the second minor dimension.

20. The system of claim 19, wherein the first major and minor dimensions are transposed 90° relative to the second major and minor dimension.

21. A splice protection housing comprising;
a length that extends between a first end and a second end;
first and second cable anchoring pockets respectively at the first and second ends;
a fiber routing and splice containment passage extending between the first and second cable anchoring pockets;
a first and second adhesive injection port respectively in communication with the first and second cable anchoring pockets; and
a first and second recessed groove respectively associated with the first and second adhesive injection ports.

22. The splice protection housing of claim 21, further comprising a plurality of barriers disposed within the fiber routing and splice containment passage configured to retain adhesive within the first and second cable anchoring pockets.

23. The splice protection housing of claim 22, further comprising a main body and a cover configured to form the fiber routing and splice containment passage when mated; and
wherein each the plurality of barriers comprise a body portion and a cover portion, wherein the body portion and the cover portion mate to form a barrier of the plurality of barriers when the main body and the cover are mated.

24. The splice protection housing of claim 22, wherein the plurality of barriers comprise at least one barrier between each of the first and second cable anchoring pockets and a central region of the fiber routing and splice containment passage.

25. The splice protection housing of claim 24, wherein the plurality of barriers comprise at least two barriers between each of the first and second cable anchoring pockets and a central region of the fiber routing and splice containment passage.
